(19) United States
(12) Patent Application Publication
(10) Pub. No.: US 2013/0007370 A1
(43) Pub. Date: Jan. 3, 2013

(54) METHOD AND APPARATUS FOR MINIMIZING WORKING MEMORY CONTENTIONS IN COMPUTING SYSTEMS

(75) Inventors: Alok Parikh, Mumbai (IN); Amandeep Singh, Fremont, CA (US)

(73) Assignee: ORACLE INTERNATIONAL CORPORATION, Redwood City, CA (US)

(21) Appl. No.: 13/175,350

(22) Filed: Jul. 1, 2011

(51) Int. Cl. G06F 12/08; G06F 12/02

(52) U.S. Cl. 711/129; 711/173; 711/E12.002; 711/E12.046

(57) ABSTRACT

Implementations of the present disclosure involve an apparatus and/or method for allocating, dividing and accessing memory of a multi-threaded computing system based at least in part on the structural hierarchy of the components of the computing system. Allocating partitions of memory based on the hierarchy structure of the computing system may isolate the threads of the computing system such that cache-memory contention by a plurality of executing threads may be reduced. In general, the apparatus and/or method may analyze the hierarchal structure of the components of the computing system utilized in the execution of applications and divide the available memory of the system between the various components. This division of the system memory creates exclusive partitions in the caches of the computing system based on the processor and cache hierarchy. The partitions may be used by different applications or by different sections of the same application to store accessed memory in cache for quick retrieval.

### FIELD OF THE INVENTION

Aspects of the present invention relate to computing systems and, more particularly, aspects of the present invention involve an apparatus and method for reducing in-cache memory contentions between software threads and/or processes of one or more software applications executed by a computing system.

### BACKGROUND

Computers are ubiquitous in today's society. They come in all different varieties and can be found in places such as automobiles, laptops or home personal computers, banks, personal digital assistants, cell phones, as well as many businesses. In addition, as computers become more commonplace and software becomes more complex, there is a need for the computing devices to perform at faster and faster speeds. One response to the desire for faster performing computing systems is the development of multi-threaded systems that execute several applications concurrently. Multi-threaded computers, however, must often share the resources and components of the computing system between the simultaneously executing threads, often times resulting in a contention for the resources within the system and interference between the executing applications. Common areas of contention within a computing system include resources such as system memory, processor time and disk access, among others. Such contention effects the overall efficiency of the computing system, including processing speed of the system.

One particularly common resource contention within a multi-threaded computing system is contention for cache memory. Cache memory is a memory device of the computing system that stores data such that the data can be accessed quickly by the processor or processors executing the multiple threads. Requested data stored in cache can generally be retrieved faster than the data retrieved from the main memory of the system. However, cache memory space is typically limited such that only the most commonly used data is stored in the cache components. In multi-threaded systems, cache contention generally occurs when two or more executing applications attempt to utilize the cache at the same time. For example, an executing application may require repeated access to data stored in cache, while also requiring access to large amounts of data to execute. By requesting large amounts of data repeatedly, the computing system will often store the data in cache memory, effectively forcing out the existing contents of the cache that may be of use to other executing applications. More particularly, data requested by other applications may be forced out of the cache by a data-heavy application such that the other applications must retrieve the data from main memory, slowing down the overall processing speed of the other applications and the computing system as a whole. In this manner, contention for memory space within the cache may limit the processing speed of a computer system.

It is with these and other issues in mind that various aspects of the present disclosure were developed.

### SUMMARY

One implementation of the present disclosure may take the form of a method for minimizing working memory contention in a computing system. The method may include the operations of allocating available memory to be used by a processing device of a multi-threaded computing system for executing one or more applications on a plurality of threads, obtaining architecture information of the components of the computing system and dividing the allocated available memory based at least in part on the architecture information of the computing system. Further, the method may include the operations of assigning the divided available memory to the plurality of threads of the multi-threaded computing system such that each thread is assigned a distinct memory chunk of the allocated available memory and executing the one or more applications on the one or more threads using the assigned dividing memory.

Another implementation of the present disclosure may take the form of a system for allocating memory of a multi-threaded computing system. The system may comprise a processing device and a computer-readable device in communication with the processing device. The computer-readable device may have stored thereon a computer program that, when executed by the processing device, causes the processing device to perform certain operations. Such operations may include obtaining architecture information of the hierarchical structure of a plurality of components of a multi-threaded computing system, dividing the available memory of the computing device among one or more threads of the computing system based at least in part on the architecture information and assigning the dividing memory to the plurality of components and the one or more threads of the computing system such that each thread accesses a distinct section of the available memory during executing of one or more applications by the one or more threads.

Yet another implementation of the present disclosure may take the form of a non-transitory computer readable medium having stored thereon a set of instructions that, when executed by a processing device, causes the processing device to perform one or more operations. Such operations may include obtaining architecture information of the hierarchical structure of a plurality of components of a multi-threaded computing system for executing one or more applications on a plurality of threads and dividing the allocated available memory based at least in part on the architecture information of the computing system. Additional operations may include assigning the divided available memory to the plurality of components and the plurality of threads of the multi-threaded computing system such that each thread executes within a distinct memory chunk of the allocated available memory and executing the one or more applications on the one or more threads using the assigned dividing memory.

### BRIEF DESCRIPTION OF THE DRAWINGS

FIG. 1 is a diagram illustrating cache contention within a computing system by cache accessing threads and memory accessing threads.

FIG. 2 is a diagram illustrating a computing system without cache contention between cache accessing threads and memory accessing threads.

FIG. 3 is a flowchart of a method for a multi-threaded computing system to divide and allocate memory to one or more threads and to access the divided memory during executing of one or more applications.

FIG. 4 is a diagram illustrating a hierarchy of components of an exemplary computing system that may be utilized by the system to divide the memory space amongst the components and software threads of the system.

FIGS. 5A and 5B illustrate a flowchart of a method for a computing system to divide and allocate chunks of memory to one or more executing threads and system components based on the hierarchy of the components of the computing system.

FIG. 6 is a diagram illustrating partitioning of available memory of an exemplary computing system based on the structural hierarchy of the computing system.

FIG. 7 is a flowchart of a method for accessing memory within a computing system where the memory has been divided and allocated to components of the system based on the structural hierarchy of the system.

FIG. 8 is a block diagram illustrating an example of a computing system which may be used in implementing embodiments of the present disclosure.

### DETAILED DESCRIPTION

Implementations of the present disclosure involve an apparatus and/or method for allocating and dividing memory of a multi-threaded computing system based at least in part on the structural hierarchy of the components of the computing system. Creating partitions of memory based on the hierarchy structure of the computing system may isolate the threads of the computing system such that cache-memory contention by a plurality of executing threads may be reduced. In general, the apparatus and/or method may analyze the hierarchical structure of the components of the computing system utilized in the execution of applications and divide the available memory of the system between the various components. This division of the system memory creates exclusive partitions in the caches of the computing system based on the processor and cache hierarchy. The partitions may be used by different applications or by different sections of the same application to store accessed memory in cache for quick retrieval. However, because the executing threads utilize separate portions of memory, use of and access to the partitioned sections by any one thread has minimal or no effect on the other partitions such that cache contentions is reduced within the computing system. Further, the reduction of cache contention between executing threads may improve the overall efficiency of the executing applications as the required time for memory retrieval by any one thread may be improved. In addition, the apparatus and/or method is deployable on any computing system with a known architectural hierarchy.

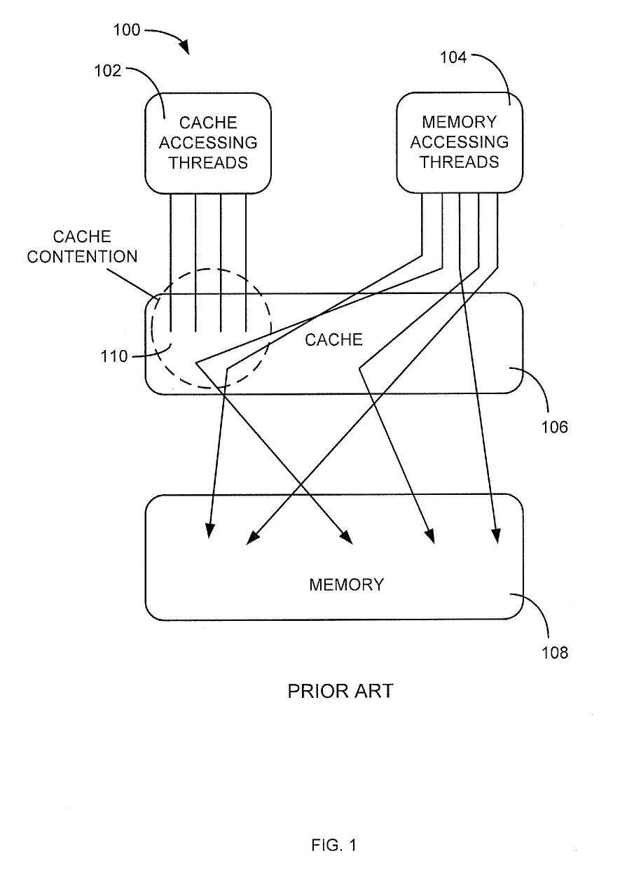

As mentioned above, memory contention within a cache component of a multi-threaded computing system may cause the system to perform slowly or below desired specifications. FIG. 1 is a diagram illustrating cache contention within a computing system by cache accessing threads and memory accessing threads. In a multi-threaded computer system 100 such as that shown in FIG. 1, any number of available threads may be executing simultaneously. For example, a single application may be executed by the computer system 100 on several threads, or multiple applications may be executed simultaneously by several threads. Further, the executing threads of a multi-threaded computing system may access cache or main memory, depending on whether the data needed by each thread is stored in the cache or main memory respectively. In general, data stored in cache is retrieved quicker than data retrieved from main memory. However, some executing applications or parts of executing applications may need data stored in main memory and will often retrieve such data from memory and store it in cache. For example, in the exemplary computing system 100 shown in FIG. 1, a plurality of threads 102 (referred to herein as “cache accessing threads”) are shown accessing cache memory 106. Additionally, a plurality of threads 104 (referred to herein as “memory accessing threads”) are shown accessing main memory 108 of the computing system 100. Both types of threads may be executed simultaneously on a multi-threaded computing system. During execution, data retrieved from main memory 108 by the memory accessing threads 104 may be subsequently stored in cache memory 106. However, this data may replace or push out other data stored in the cache memory 106. As a result, data requested by the cache accessing threads 102 may not be present when requested. This situation results in cache contention 110 as data requested by cache accessing threads 102 from the cache 106 has been replaced by data retrieved by memory accessing threads 104. As mentioned above, cache contention 110 may result in undesirable performance of the computing system 100.

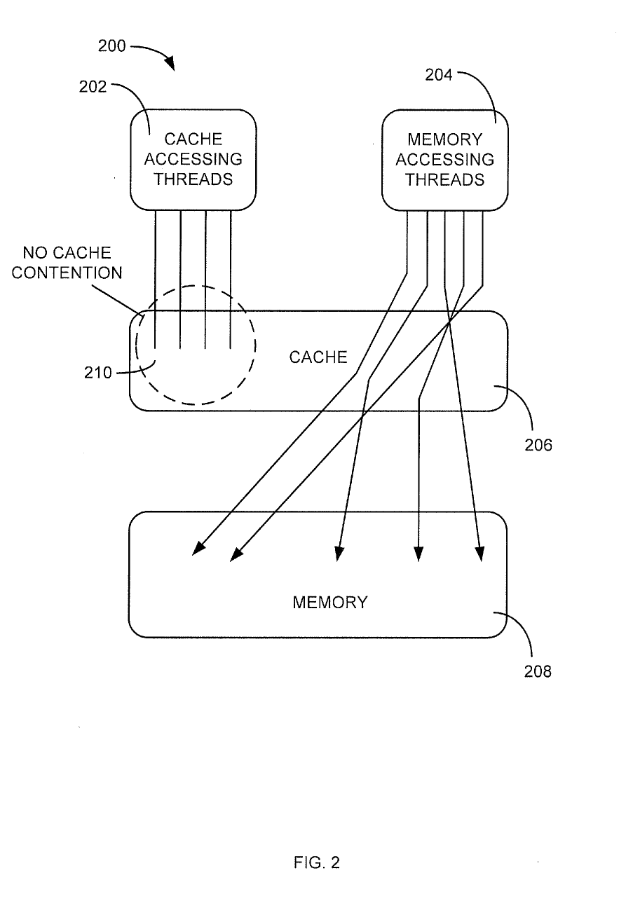

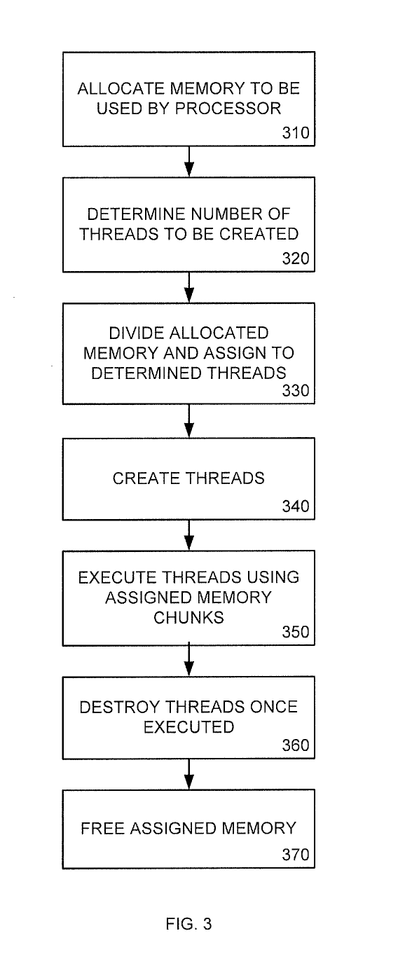

One method to address the issue of cache contention is to partition the memory of the computing system into chunks assigned to the components of the system based at least in part on the structural hierarchy of the computing system. In general, partitioning the memory of the system among the components of the system ensures that data requested by cache accessing threads 102 remains in cache for as long as needed by the thread. For example, FIG. 2 is a diagram illustrating a computing system 200 without cache contention between cache accessing threads 202 and memory accessing threads 204. In general, the computing system 200 of FIG. 2 is the same computing system of FIG. 1, except the system memory has been partitioned among and assigned to the components of the system based at least in part on the structural hierarchy of the computing system. As a result of the memory partitioning, the memory accessing threads 204 may retrieve data through a portion of the cache 206 such that any data retrieved by the memory accessing threads remains separate from the data requested by the cache accessing threads 202. In this manner, cache contention is reduced and the computing system may operate more efficiently. In other embodiments, the memory accessing threads 204 may also be partitioned from each other such that there is no overlap of memory accessed by the memory accessing threads as well. In other words, the memory accessing threads may access certain segments of the main memory 208 such that no executing threads overlap with another executing thread. The particulars of one embodiment of a method of partitioning memory of a computing system to minimize or prevent cache contention within the system is provided herein with respect to FIGS. 3 through 7.

FIG. 3 is a flowchart of a method for a multi-threaded computing system to allocate and divide memory among the components and threads of the system and to access the divided memory during executing of one or more applications. The allocation and division of the memory may be performed by the computing device through hardware, software or a combination of both hardware and software. For example, in one embodiment, a software application can allocate and divide the memory for use by the one or more software threads when executing applications on the computing device. In another embodiment, the allocation and division can be included in the operating system of the computing device, such as through one or more application program interfaces (APIs). In yet another embodiment, the memory division may occur through the design of the computing device such that the memory division is implemented through the structure of the computing system. Further still, the memory allocation and division may be performed by the computing system through physical address mapping or through virtual memory distribution controlled through software. In general, any method known or hereafter developed to allocate and divide memory locations to one or more components or one or more threads of a multi-threaded computing system, either through a software or hardware configuration, may perform the operations described below. As such, the term “computing system” used below to describe the performing of the operations may embody any of the above described systems.

Beginning in operation 310, the computing system may allocate the memory to be used by the processor to execute one or more applications on the one or more threads of the multi-threaded computing system. The allocated memory may be based on the processing and data needs of the executing application and includes some portion of the available overall memory of the computing system. In operation 320, the computing system may determine the number of threads to be created to execute the one or more applications. The number of created threads may be based on the number of simultaneously executing applications, the number of threads of the multi-threaded computing system, the processing needs of the executing threads, and any other performance considerations of a multi-threaded computing system capable of executing several applications simultaneously.

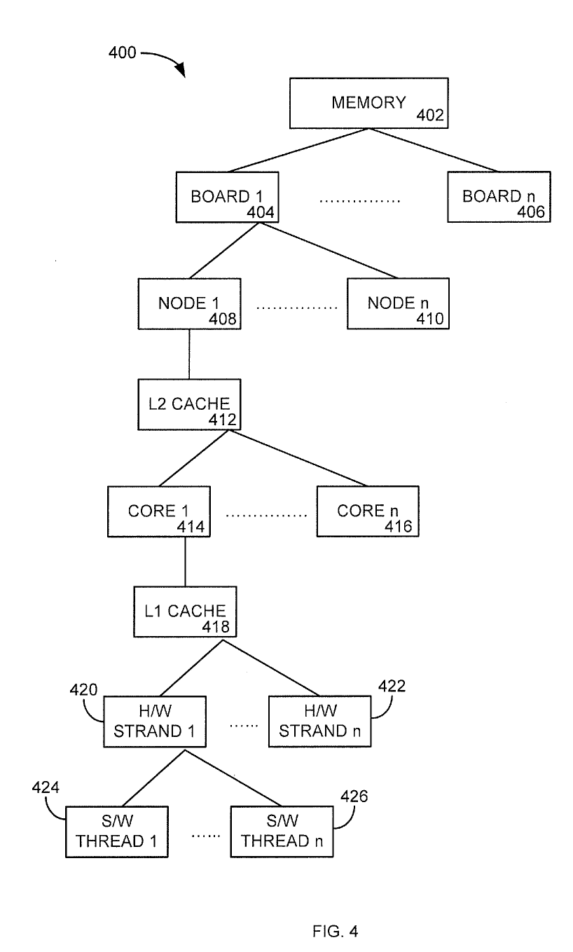

Once the memory is allocated and the number of threads is determined, the computing system may divide the allocated memory among the threads and assign the divided memory to the determined number of threads in operation 330. In one embodiment, the division of the allocated memory among the determined number of threads may be based at least in part on the structural hierarchy of the computing system. For example, each thread may be associated with particular components of the computing system to execute the one or more applications. Thus, by determining the structural hierarchy of each thread of the computing system, the memory may be divided among the threads and the associated components of the computing system. Such a division of the memory is described below in more detail with reference to FIGS. 4 through 6. In general, the division of the memory based on the structural hierarchy of the computing system may diminish contention within the memory system by the executing threads.

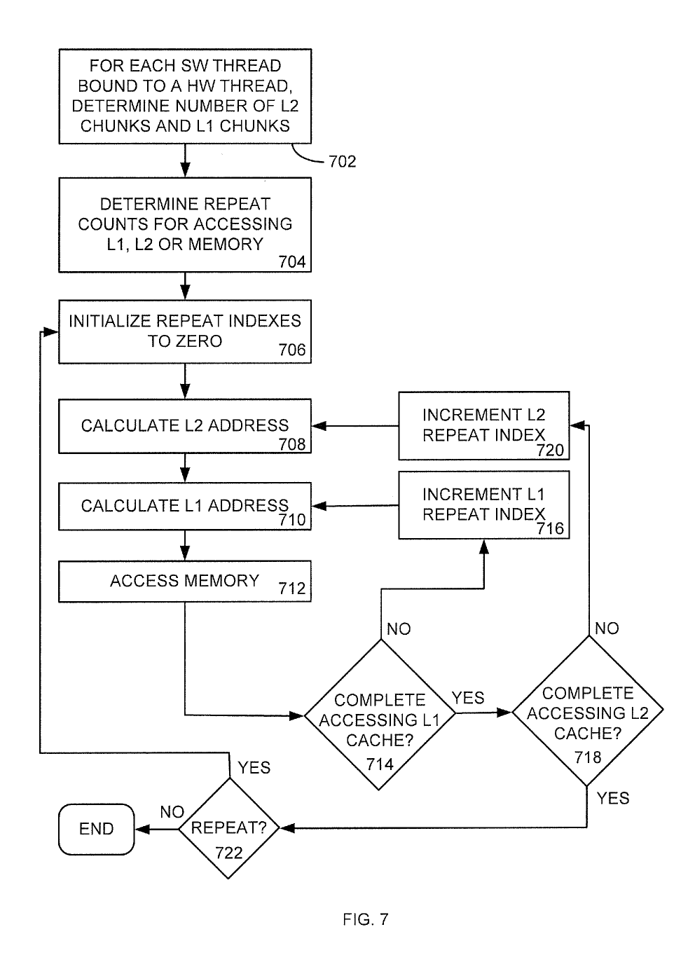

In operation 340, the computing system may create the software or hardware threads to execute the one or more applications. The number of created threads may be determined in operation 320, discussed above. For example, the operating system of the computing system or the application may determine the number of threads to execute the applications on the system and create one or more threads to execute the applications. Once the determined number of threads are created, the computing system may execute the one or more applications utilizing the created threads in operation 350. During execution, the threads may utilize the chunks of memory allocated and assigned to each thread in operation 330. In this manner, the executing threads may be maintained separate in memory such that contention for memory space by the executing threads is minimized. One particular embodiment of a method for the computing system to access the partitioned memory is provided in more detail below with reference to FIG. 7.

Once the one or more applications are executed or completed, the created threads may be destroyed by the computing system in operation 360. In addition, the allocated and assigned memory may be freed in operation 370. Once the threads are destroyed and the memory freed, the computing system is available to execute further applications by repeating the operations of FIG. 3.

As mentioned above, the memory of a computing system may be divided among the executing threads of the system to minimize the memory contention that occurs while executing some applications, such as in operation 330 of FIG. 3. In one embodiment of the present disclosure, the division and assigning of the memory may be based at least in part on the structural hierarchy of the threads and components of the computing system. FIG. 4 is a diagram illustrating a hierarchy of threads and components of an exemplary computing system 400 that may be relied on to divide the memory space of the system amongst the components and threads to minimize the memory contention within the system. The computing system 400 of FIG. 4 is but one example of a computing system hierarchy. Those of ordinary skill in the art will recognize that computing systems come in many forms and structures. Thus, a computing system may include any number of the components shown in FIG. 4, as well as additional components not shown. As should be appreciated, the methods disclosed herein for allocating, dividing and assigning memory chunks based on the hierarchy of the computing system applies to any hierarchical computing system structure, such as that of FIG. 4 or systems including fewer or more components.

The structural hierarchy of any computing system may be obtained by the computing device from several sources. In one embodiment, the system structure may be maintained by an operating system program executed by the computing system. This operating system may be probed by the computing system or a program executing on the computing system to retrieve the computer system hierarchy and component inter-relationship. In another embodiment, the system structure may be included within a program that performs the methods described herein. For example, such structure may be hard-coded within the program that divides and allocates the memory of the system based on the system structure. In yet another embodiment, the structural information may be stored in one or more storage components of the system for retrieval by a program or application executed by the system. Regardless of the manner in which the computer system structure is obtained or provided, the available memory of the system may be allocated, divided and assigned to the components and the threads of the system based on such structural information.

The computing system 400 of FIG. 4 has a main memory 402 that is at least partially shared by the components of the computing system. While a single main memory component 402 is shown in FIG. 4, some computing systems may include a plurality of main memory modules that are shared by the components of the system. Thus, the methods described herein to partition memory of a computing system may be applied to any memory component of the system. For example, for those computing systems that have a plurality of main memory components, each memory component may be partitioned based on the structure of the system components that are associated with the memory components. For simplicity, however, the computing system 400 of FIG. 4 is shown with a single main memory component 402 that represents the available memory of the system 400.

The computing system 400 also includes any number of system boards 404, 406 that utilize the main memory 402 of the system. For example, in some high-end computing devices, several motherboards may share a memory component between the boards. The multiple boards are illustrated in FIG. 4 as Board 1 404 through Board n 406. It should be appreciated that computing systems may include any number of boards, from a single motherboard to several such boards. Further, each board 404, 406 of the computing system may be associated with one or more processing nodes 408, 410 in direct communication with the board. In general, the processing nodes 408, 410 of the computing system may be implemented in hardware or in software within the associated board. The multiple nodes of the computing system are illustrated in FIG. 4 as Node 1 408 through Node n 410. As shown, each board 404, 406 may include any number of processing nodes 408, 410 associated with the boards for processing applications within the computing system 400.

The computing system 400 may also include an L2 cache component 412 associated with each Node 408, 410 of the computing system 400. In this configuration, each node 408, 410 accesses an associated L2 cache 412 during execution of the applications by the system 400. In addition, one or more cores 414, 416 may also be associated with each node and accompanying L2 cache component such that the nodes and L2 caches may be divided into the associated cores. The cores are shown in FIG. 4 as Core 1 414 through Core n 416 and are associated with L2 cache 412. Thus, in this configuration, several processing cores 414, 416 share an associated L2 cache 412. Further, each core 414, 416 of the computer system 400 may have an associated L1 cache component 418 such that each core may utilize the accompanying L1 cache during execution of the applications.

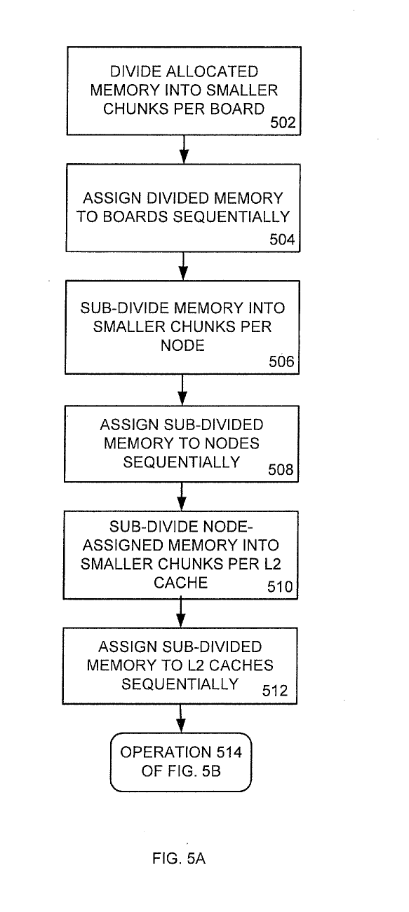

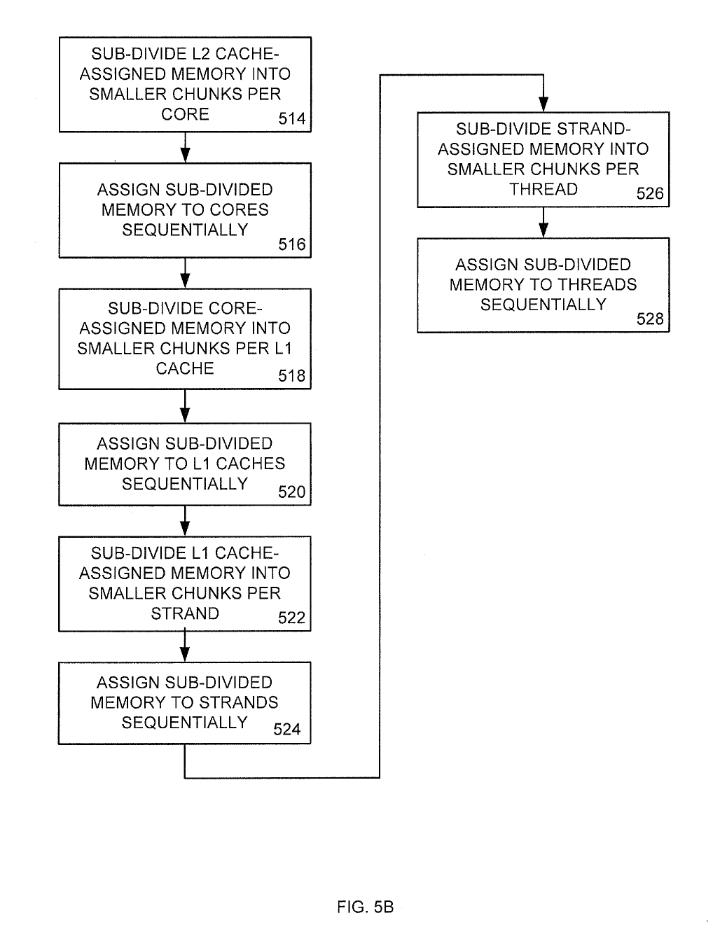

In addition, each core 414, 416 may be further divided into one or more hardware strands 420, 422, as shown as Hardware Strand 1 420 through Hardware Strand n 422. Finally, each hardware strand 420, 422 may allow multiple software threads from an application to execute on itself, as illustrated in FIG. 4 as Software Thread 1 424 through Software Thread n 426. As described below with reference to FIGS. 5A-5B, this computing system 400 structure may be used to allocate the memory components of the system to the one or more execution threads. Also, as mentioned above, the computing system 400 of FIG. 4 is but one example of a computing system that can be divided based on the computing system hierarchy.

FIGS. 5A and 5B illustrate a flowchart of a method for a computing system to divide and allocate chunks of memory to one or more executing threads and system components based on the hierarchy of the components of the computing system. More particularly, the method illustrated in FIGS. 5A and 5B is for dividing and allocating the system memory for the computing system illustrated in FIG. 4. However, one or more of the operations described below may be performed to divide the available memory for any computing system by adding or removing some operations to those described. The application of the described operations to other computing systems will be clear to those of ordinary skill in the art. In addition, the operations of FIGS. 5A and 5B may be performed by the operating system or other software of the computing device for allocating memory to executing threads. In other embodiments, the division of the memory based on the system hierarchy may be implemented through the hardware and design of the system.

In general, the operations described in relation to FIGS. 5A and 5B may be performed to sub-divide the memory of a computing system into partitions based on the structural hierarchy of the system. Thus, beginning at the highest level of the computer structure, the available memory may be divided and sub-divided for each level of components of the system until each thread of the computing system has a portion of the memory dedicated to each of the executing threads. By partitioning the memory amongst the executing threads, contention in the memory or cache by the threads may be reduced as each executing thread is contained within its allocated memory chunk.

Beginning in operation 502, the computing system may determine the number of boards for an available main memory component and divide the available memory within the memory component among the boards. In operation 504, the divided memory may then be assigned or allocated to the determined number of boards associated with that memory component. For example, in a computing system where the memory component supports two boards, the available memory of the memory component is divided in half, with the first half being allocated for the first board and the second half allocated for the second board. In one embodiment, the available memory of the memory component is divided and assigned in whole or contiguous chunks to the boards of the system. In other embodiments, however, the available memory space may be assigned to the boards in any fashion, as long as the available memory chunks are evenly distributed. For example, if the memory component includes 1 GB of available memory space in support of two boards, each board may be assigned 512 MB of memory space in any fashion, such that the memory accessed by the two boards are separately allocated. In a system with three boards supported by a 1 GB main memory, each board may be assigned 341.33 MB of available memory space. In addition, the chunks of memory may be assigned to the boards sequentially, such as beginning with Board 1 up to Board n of the system illustrated in FIG. 4. In addition, in some embodiments, the division of the memory may not be equal among the components of the system. For example, one board of the system may be allocated more memory than another board in operation 504. Thus, each memory chunk assigned to the components of the system may be any size as desired.

In operation 506, the computing system sub-divides the memory chunks assigned to the boards into smaller chunks based on the number of nodes of the system. The sub-divided chunks of memory from operation 506 are then assigned to the nodes of the system sequentially in operation 508. For example, the memory chunk assigned to Board 1 404 of the computing system 400 of FIG. 4 may be further divided among the nodes of the system assigned to Board 1. Thus, the memory chunk assigned to Board 1 is sub-divided between Node 1 408 through Node n 410. The division and assigning of the memory among the nodes of the computing system may be similar to the division and assigning among the boards of the system described above in relation to operations 502 and 504. Thus, the memory may be sub-divided among any number n of nodes of the system and may be of any size. Further, the division may occur sequentially from node 1 through node n and each chunk may be contiguous or may be fragmented throughout the available memory.

The division of the memory based on the hierarchal structure of the computing system may continue in operations 510 and 512 by the sub-division of each node-assigned chunk of memory into smaller chunks based on the L2 cache components for each node. Once divided, the sub-divided memory chunks may then be assigned to the L2 caches of the system sequentially in operation 512. However, the computer system 400 shown in FIG. 4 provides for a dedicated L2 cache component 412 for each node of the system such that each node only accesses the L2 cache associated with that node. In this configuration, the memory partitions assigned to each node would not need to be further sub-divided among the L2 cache assigned to each node since each node has a single associated L2 cache component. Thus, the memory chunks assigned to each node of the system would also be assigned to each L2 cache component respectively to associated nodes. In other embodiments where the a plurality of L2 cache components are associated with the nodes of the system, operations 510 and 512 may be performed to further sub-divide the system memory among L2 caches to further isolate memory accesses among the executing threads.

Continuing to operation 514 of FIG. 5B, the memory chunks assigned to each L2 cache (whether sub-divided from the memory chunks assigned to each node or the same as the memory chunks assigned to each node) may be further sub-divided into smaller chunks per core associated with each L2 cache in operation 514. Similar to those operations described above, the memory chunks of the L2 cache components may be sub-divided among any number of cores associated with each L2 cache. Once sub-divided, the smaller chunks of system memory may be assigned to each core such that each core only accesses a particular portion of the system memory. In addition, the sub-division of the memory chunks assigned to the L2 cache assures that each core accessing the L2 cache component is portioned within the cache to minimize cache contention within the system.

In a similar manner, the memory of the system may be continually divided and sub-divided based on the hierarchy of the computing system. Thus, using the system of FIG. 4 as an example, the memory chunks assigned to each core may be further sub-divided among the L1 caches associated with each core in operation 518. The sub-divided portions may also be assigned to the L1 caches in operation 520. Similar the L2 caches discussed above, each L1 cache of the exemplary computing system is associated with a single core such that the memory chunk assigned to the each core is the same as the memory chunk assigned to its associated L1 cache. However, this may not always be the case as some systems may provide a plurality of L1 caches for each core, such that the memory space may be further divided among the L1 caches.

In operation 522, the memory portions assigned to the L1 caches may be sub-divided into smaller chunks based on number of hardware strands associated with the L1 cache in a similar manner as described above. Such sub-divided chunks may be assigned to the hardware strands sequentially among the number of hardware strands per L1 cache in operation 524. Similarly, the memory may be sub-divided further based on the number of software threads per hardware strand in operation 526 and assigned to the software threads in operation 528. Through these operations, the memory of the computing system may be divided among the available software threads and components of the system such that each executing thread may access certain portions of the available memory, thereby reducing contention within the memory components of the system.

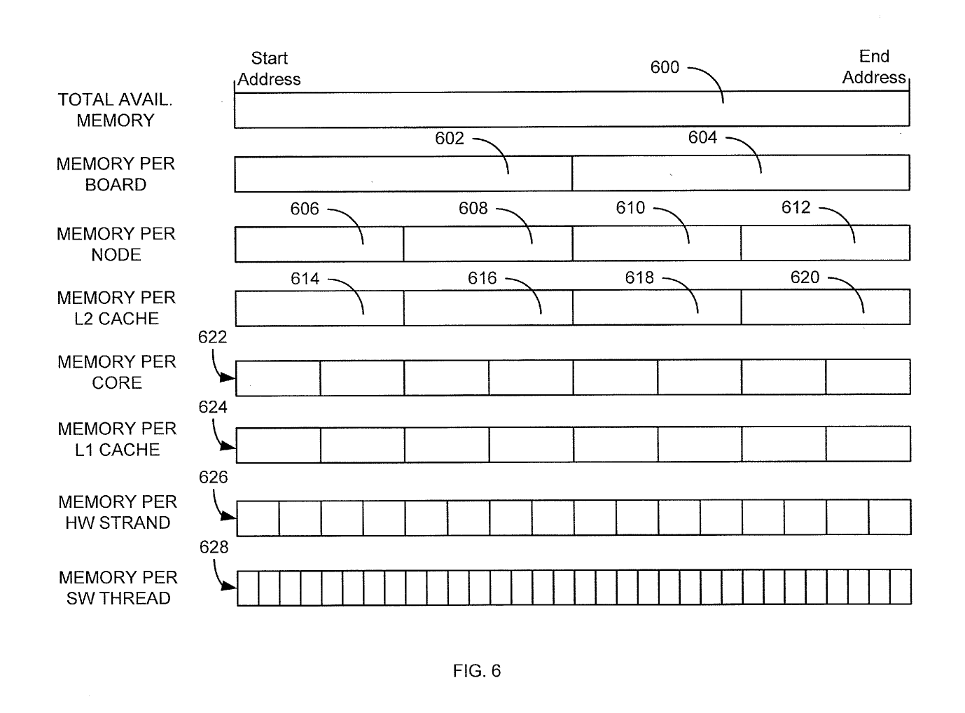

FIG. 6 is a diagram illustrating partitioning of available memory of an exemplary computing system based on the structural hierarchy of the computing system through the operations of the flowcharts of FIG. 5A and 5B. However, the partitioning illustrated is but one example of partitioning of the available memory that may take place in a particular computing system. As explained in more detail below, aspects of the partitioning shown may vary significantly based on the structural relationships and overall design of the components of the computing device being partitioned. Thus, the partitioning of the available memory of FIG. 6 is provided for illustrative reasons only.

As described above, the computing system may include an overall available memory for executing one or more applications by the computing device. Such overall available memory of the computing system is shown at the top of FIG. 6 as rectangular box 600. The box, beginning at “Start Address” to “End Address”, illustrates the chunk of overall available memory space to be divided among the components and threads of the system. For example, the total available memory 600 of the computing system may be 1 GB of memory space, addressable by the memory range from Start Address to End Address. As explained above, the address range of the available memory may be a continuous chunk, or may located in several places within the memory components of the system. Thus, the Start Address and End Address of the system memory 600 may be a virtual addressing system that represents the overall available memory. Regardless of the particulars of the available memory of the computing system, such memory may be divided and allocated to the components of the system based on the system hierarchy as described in the operations of FIG. 5A and 5B.

Beginning with operation 502, the available system memory 600 may be divided into smaller chunks per board of the computing system. In the example shown in FIG. 6, the computing system has two boards that share the main memory 600 such that the available memory is divided between the two boards into memory range. In those computing systems that have more than two boards that share the memory, the available memory 600 of the system may be divided among the total number of boards. Also, once divided, the memory chunks may be assigned to the boards of the system sequentially. Thus, memory chunk 602 is assigned to the first board and memory chunk 604 is assigned to the second board. In the example shown, each board is assigned an equal size of the divided memory. However, this is not required as the assigned memory chunks may be of disparate size.

Continuing on, each memory chunk assigned to each board is further sub-divided into smaller chunks based on the number of nodes associated with each board. In the example shown, each board has two nodes such that the memory chunk assigned to each board is divided evenly among the nodes associated with that board. For those computing systems that include more than two nodes per board, the memory may be divided based on the total number of nodes for that particular board. Further, in some computing systems, the number of nodes associated with each board may vary. For example, Board 1 may include two nodes while Board 2 includes three nodes. In such a configuration, the memory chunk assigned to Board 1 may be divided in half while the memory chunk assigned to Board 2 may be divided in thirds. In other words, the division of each memory chunk assigned to the board is at least partially based on the number of nodes associated with that board. Once the per-board memory chunks are sub-divided based on the number of nodes associated with each board, the sub-divided memory chunks are assigned to the nodes sequentially. Thus, in the example shown, memory chunk 606 is assigned to a first node of a first board, memory chunk 608 is assigned to a second node of the first board, memory chunk 610 is assigned to a first node of a second board and memory chunk 612 is assigned to a second node of the second board.

Additionally, the computing system illustrated in FIG. 6 is configured such that each node is associated with a dedicated L2 cache component, similar to the computing system shown in FIG. 4. Thus, the memory chunk assigned to each L2 cache is the same as that assigned to each node such that memory chunk of the main memory from which the L2 cache retrieves data from is the same size and within the same memory address range as the associated node. However, in those computing systems where a node may be associated with a plurality of L2 cache components, the memory chunk assigned to each node may be sub-divided as described above such that the L2 cache components access distinct areas of memory within the main memory.

The method of sub-dividing and assigning continues until memory chunks per core 622, memory chunks per L1 cache 624, memory chunks per hardware strand 626 and memory chunks per software thread 628 are divided and assigned. However, it should be noted that the divisions shown in FIG. 6 divide each assigned memory chunk in half. In other computing system designs where more than two components depend upon another component, the memory chunks would be divided further. Additionally, other computing system configurations (such as those with more components, fewer components, alternative connections between the components) may result in the division of the available memory 600 into different sized chunks and assigned to different components. In general, the operations of dividing and assigned chunks of the main memory to the components of the computing system based on the system hierarchy are disclosed above.

A result of the method of dividing and assigned memory chunks to the components of the system is that each executing software thread accesses a dedicated portion of the main memory for execution of an associated application. For example, each box of the memory per software thread 628 of FIG. 6 illustrates an assigned chunk of the main memory for each software thread of the computing system. Thus, each software thread would utilize the assigned chunk of main memory to execute an application on the computing system. Further, other components, such as the L2 cache and the L1 cache, accessed by the executing threads during executing of an application are also partitioned within main memory such that contention for space within the cache space between the executing threads is thereby minimized. This partitioning of the available memory 600 among the threads and components reduces contention within the memory components of the system as each thread executes within its allocated partition.

FIG. 7 is a flowchart of a method for accessing memory within a computing system where the memory has been divided and allocated to components of the system based on the structural hierarchy of the system. While FIG. 7 is one example of accessing the memory components (main memory, L2 cache and L1 cache) of a system wherein the memory has been divided and allocated among the components and threads of the system, those skilled in the art will recognized that many methods may be applied to a computing system for accessing the memory of the system. As such, it is not a requirement that computing systems whose memory has been allocated among the components of the system through the methods described above utilize the method of FIG. 7 to access said memory. Rather, the method of FIG. 7 is provided as an example of one possible method for accessing the divided memory.

Beginning in operation 702, the computing system may determine the number of memory chunks that are to be accessed and the number of times the chunk is to be accessed. More particularly, for each software thread bound to a hardware strand, the computing system may determine how many times and how many stand assigned memory chunks, as determined in operation 526, the thread accesses to bring about access to the L1 cache. Similarly, the computing system may determine how many times and how many L1 cache assigned memory chunks, as determined in operation 522, the thread accesses to bring about access to the L2 cache. Furthermore, the computing system may determine how many times and how many L2 cache assigned memory chunks, as determined in operation 512, the thread accesses to bring about access to main memory

In operation 704, the computing system determines the repeat counts for accessing the L1 cache, the L2 cache and/or memory. If the executing thread is accessing the L1 cache only, the computing system sets an L1 repeat count to one and an L2 repeat count to one. For accessing the L2 cache, the L1 repeat count is set to the number of L1 chunks determined in operation 702 above and the L2 repeat count is set to one. Thus, in the above example for L2 accesses, the computing system sets the L1 repeat count to two and the L2 repeat count to one. To access the main memory, the computing system sets the L1 repeat count to the number of L1 chunks determined in operation 702 above and the L2 repeat count to the number of L2 chunks determined in operation 702. Continuing the above example, for memory access, the L1 repeat count is set to two and the L2 repeat count is set to four.

Continuing to operation 706, the computing system sets the L1 index count and an L2 index count to zero. In operation 708, the executing thread then calculates an address for L2 cache access. In one example, the address calculate in operation 708 may equal the starting point in memory assigned to the executing thread plus the size of the L2 memory chunk multiplied by the L2 index count. For example, the first time through the flow chart, the L2 access address equals the starting address assigned to the executing thread. However, as explained in more detail below, subsequent iterations of operations 702 may calculate the L2 access address as the starting address in memory for each chunk of memory assigned to the L2 cache associated with the executing thread. In other words, the thread may access the memory chunks assigned to the L2 cache sequentially as the L2 repeat index number is incremented. This feature of the method of FIG. 7 is described in more detail below.

In operation 710, the computing system may also calculate a start address within memory allocated to the L1 cache. In one example, the L1 address may equal the starting point in memory assigned to the L1 cache plus the size of the L1 memory chunks multiplied by the L1 index count. For example, the first iteration through the method would result in the L1 access address equaling the beginning of the memory chunk assigned to the executing thread. The calculated L1 access address may be utilized by the computing system in operation 712 to access the memory. In this manner, the executing thread may read and write data to the particular section of memory allocated to that thread as the L1 access address equals the thread start address. Further, the point of access within the memory of operation 712 at this time is the first address within the first L1 cache associated with the executing thread.

Once the memory has been accessed, the computing system may determine in operation 714 whether access to the associated L1 caches is complete. To determine whether the access to the L1 cache is complete, the computing system may compare the L1 index count to the L1 repeat count. If equal, than access to the L1 cache is complete. However, if the L1 index count does not equal the L1 repeat count, the computing system may continue to operation 716 where the L1 index count is incremented. Once incremented, the computing system may return to operation 710 and recalculate the L1 address. Continuing example, the L1 access address now becomes the beginning point in memory of the next L1 cache associated with the executing thread. In this manner, operation 710 through 716 may be repeated by the computing system to sequentially access the L1 caches associated with the executing thread.

If, in operation 714, the L1 index count equals the L1 repeat count, the computing system may thus determine that access to each L1 cache is complete. Therefore, in operation 718, the system may further determine whether the access to the L2 cache is complete. Similar to operation 714, the determination of whether L2 cache access is complete may be determined by comparing the L2 index count to the L2 repeat count. If not equal, the computing system may continue to operation 720 and increment the L2 index count. Once incremented, the computing system may return to operation 708 and recalculate the L2 access address. In a similar manner to the operations to access the L1 cache, operations 708, 710, 712, 714, 718 and 720 may be repeated to access the L2 caches associated with an executing thread sequentially.

If, in operation 718, the computing system determines that the L2 index count and the L2 repeat count are equal, the computing system may then continue to operation 722 and determine if a new memory access is requested by the executing thread. If memory access is complete, the method may conclude. However, if additional memory accesses are requested by the executing thread, then the computing system may return to operation 706 to repeat the memory access. Thus, through the method of FIG. 7, the computing system may access memory that is divided and allocated based at least on the structural hierarchy of the computing system.

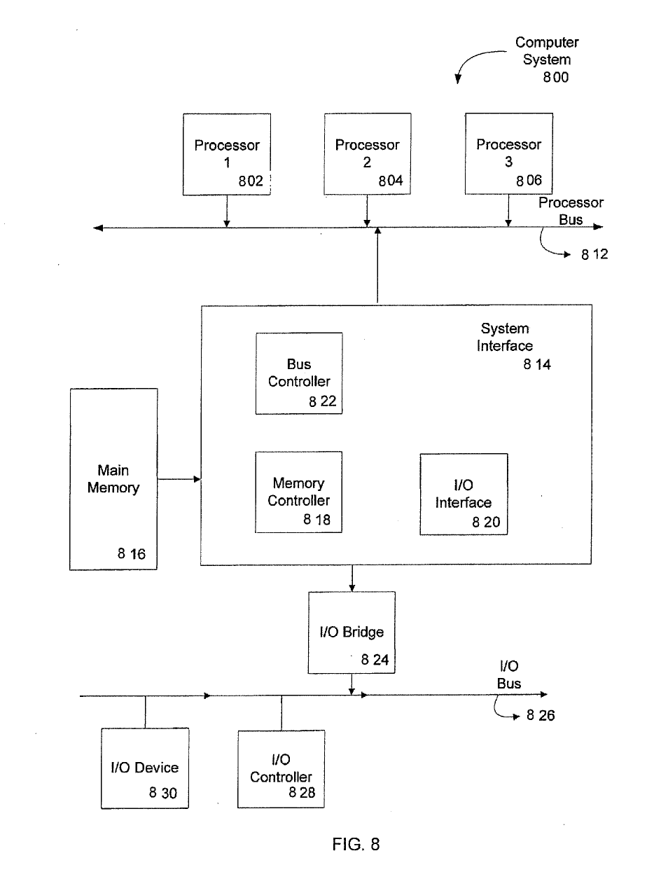

As mentioned above, the methods and operations described herein may be performed by an apparatus or computing device. FIG. 8 is a block diagram illustrating an example of a computing device or computer system 800 which may be used in implementing embodiments of the present invention. The computer system (system) includes one or more processors 802-806. Processors 802-806 may include one or more internal levels of cache (not shown) and a bus controller or bus interface unit to direct interaction with the processor bus 812. Processor bus 812, also known as the host bus or the front side bus, may be used to couple the processors 802-806 with the system interface 814. System interface 814 may be connected to the processor bus 812 to interface other components of the system 800 with the processor bus 812. For example, system interface 814 may include a memory controller 818 for interfacing a main memory 816 with the processor bus 812. The main memory 816 typically includes one or more memory cards and a control circuit (not shown). System interface 814 may also include an input/output (I/O) interface 820 to interface one or more I/O bridges or I/O devices with the processor bus 812. One or more I/O controllers and/or I/O devices may be connected with the I/O bus 826, such as I/O controller 828 and I/O device 830, as illustrated.

I/O device 830 may also include an input device (not shown), such as an alphanumeric input device, including alphanumeric and other keys for communicating information and/or command selections to the processors 802-806. Another type of user input device includes cursor control, such as a mouse, a trackball, or cursor direction keys for communicating direction information and command selections to the processors 802-806 and for controlling cursor movement on the display device.

System 800 may include a dynamic storage device, referred to as main memory 816, or a random access memory (RAM) or other computer-readable devices coupled to the processor bus 812 for storing information and instructions to be executed by the processors 802-806. Main memory 816 also may be used for storing temporary variables or other intermediate information during execution of instructions by the processors 802-806. System 800 may include a read only memory (ROM) and/or other static storage device coupled to the processor bus 812 for storing static information and instructions for the processors 802-806. The system set forth in FIG. 8 is but one possible example of a computer system that may employ or be configured in accordance with aspects of the present disclosure.

According to one embodiment, the above techniques may be performed by computer system 800 in response to processor 804 executing one or more sequences of one or more instructions contained in main memory 816. These instructions may be read into main memory 816 from another machine-readable medium, such as a storage device. Execution of the sequences of instructions contained in main memory 816 may cause processors 802-806 to perform the process steps described herein. In alternative embodiments, circuitry may be used in place of or in combination with the software instructions. Thus, embodiments of the present disclosure may include both hardware and software components.

A machine readable medium includes any mechanism for storing or transmitting information in a form (e.g., software, processing application) readable by a machine (e.g., a computer). Such media may take the form of, but is not limited to, non-volatile media and volatile media. Non-volatile media includes optical or magnetic disks. Volatile media includes dynamic memory, such as main memory 816. Common forms of machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions.

It should be noted that the flowcharts of FIGS. 3, 5A, 5B and 7 are illustrative only. Alternative embodiments of the present invention may add operations, omit operations, or change the order of operations without affecting the spirit and scope of the present invention.

The foregoing merely illustrates the principles of the invention. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the invention and are thus within the spirit and scope of the present invention. From the above description and drawings, it will be understood by those of ordinary skill in the art that the particular embodiments shown and described are for purposes of illustrations only and are not intended to limit the scope of the present invention. References to details of particular embodiments are not intended to limit the scope of the invention.

What is claimed is:

1. A method for minimizing working memory contention in a computing system, the method comprising:
allocating available memory to be used by a processing device of a multi-threaded computing system that uses a plurality of threads;
obtaining architecture information of a plurality of components of the computing system;
dividing the allocated available memory based at least in part on the architecture information of the computing system;
assigning the divided allocated available memory to the plurality of threads of the multi-threaded computing system such that at least a first thread is assigned to a first distinct memory chunk of the allocated available memory and a second thread is assigned to a first distinct memory chunk of the allocated available memory; and
accessing the assigned divided memory chunk based at least in part on the architecture of the computing system during execution of the one or more applications on the one or more threads.

2. The method of claim 1 wherein the architecture information of the computing system includes hierarchal information of the interconnectivity of the plurality of components of the computing system.

3. The method of claim 1 wherein the architecture information of the computing system includes hierarchal information of the components associated with a particular thread of the plurality of threads.

4. The method of claim 1 wherein the dividing operation comprises:
dividing the allocated available memory between one or more processor boards of the computing system.

5. The method of claim 4 wherein the dividing operation further comprises:
sub-dividing the allocated available memory between one or more processing nodes associated with the one or more processor boards of the computing system.

6. The method of claim 5 wherein the dividing operation further comprises:
sub-dividing the allocated available memory between one or more L2 cache components associated with the one or more processing nodes of the computing system.

7. The method of claim 6 wherein the dividing operation further comprises:
sub-dividing the allocated available memory between one or more cores associated with the one or more L2 cache components of the computing system.

8. The method of claim 7 wherein the dividing operation further comprises:
sub-dividing the allocated available memory between one or more L1 cache components associated with the one or more cores of the computing system.

9. The method of claim 8 wherein the dividing operation further comprises:
sub-dividing the allocated available memory between one or more hardware strands associated with the one or more L1 cache components of the computing system.

10. The method of claim 1 wherein the assigning operation comprises:
assigning the divided memory sequentially to the plurality of threads.

11. The method of claim 1 wherein the assigning operation comprises:
assigning the divided memory evenly among the plurality of threads.

12. The method of claim 1 wherein the assigning operation comprises:
assigning the divided memory unevenly among the plurality of threads such that at least one thread is assigned more memory than at least one other thread.

13. A system for allocating memory of a multi-threaded computing system comprising:
a processing device; and
a computer-readable device in communication with the processing device, the computer-readable device having stored thereon a computer program that, when executed by the processing device, causes the processing device to perform the operations of:
obtaining architecture information of the hierarchal structure of a plurality of components of a multi-threaded computing system;
dividing the available memory of the computing device among one or more threads of the computing system based at least in part on the architecture information; and
assigning the divided allocated available memory to the plurality of threads of the multi-threaded computing system such that at least a first thread is assigned to a first distinct memory chunk of the allocated available memory and a second thread is assigned to a first distinct memory chunk of the allocated available memory.

14. The system of claim 13 wherein the architecture information includes interconnectivity information of the plurality of components of the multi-threaded computing system.

15. The system of claim 13 wherein the obtaining operation further comprises:
receiving the architecture information from an operating system stored in the computer-readable device.

16. The system of claim 13 wherein the obtaining operation further comprises:
requesting the architecture information from the computer-readable device.

17. The system of claim 13 wherein the processing device further performs the operation of:
sub-dividing the available memory of the computing device among one or more L1 cache components and L2 cache components.

18. A non-transitory computer readable medium having stored thereon a set of instructions that, when executed by a processing device, causes the processing device to perform the operations of:
obtaining architecture information of the hierarchal structure of a plurality of components of a multi-threaded computing system for executing one or more applications on a plurality of threads;
dividing the allocated available memory based at least in part on the architecture information of the computing system;
assigning the divided allocated available memory to the plurality of threads of the multi-threaded computing system such that at least a first thread is assigned to a first distinct memory chunk of the allocated available memory and a second thread is assigned to a first distinct memory chunk of the allocated available memory; and
accessing the assigned divided memory chunk based at least in part on the architecture of the computing system during execution of the one or more applications on the one or more threads.

19. The computer readable medium of claim 18 wherein the instructions further cause the processing device to perform the operations of:
sub-dividing the available memory of the computing device among one or more L1 cache components and L2 cache components to minimize in-cache contention between the one or more executing threads.

20. The computer readable medium of claim 18 wherein the instructions further cause the processing device to perform the operations of:
retrieving data from the assigned available memory by sequentially accessing one or more L1 caches and L2 caches of the computing system.
